(19) United States
(12) Patent Application Publication
(10) Pub. No.: US 2004/0203611 A1
(43) Pub. Date: Oct. 14, 2004

(54) Architecture and services for wireless data

(76) Inventors: Thomas F. Laporta, Holmdel, NJ (US); Scott C. Miller, Freehold, NJ (US); Krishnan K. Sabnani, Westfield, NJ (US); Thomas Y. Woo, Red Bank, NJ (US)

Correspondence Address: HARNESS, DICKEY & PIERCE, P.L.C., P.O. Box 8910, Reston, VA, 20195, US

(21) Appl. No.: 10/158,006

(22) Filed: May 31, 2002

(51) Int. Cl. H04M 11/10

(52) U.S. Cl. 455/412.1; 455/418

(57) ABSTRACT

The method provides a variety of services in a wireless data network including destination devices using a wireless or Internet interface connected to a server. Messages including destination information and recorded voice data are created and transferred over the interface. In one embodiment, the messages are transferred as non-real time data from the mobile station to the server, and then from the server to the destination devices identified in the message destination information. The server may also provide voice processing thereby enabling voice control services and wide area remote control services. Furthermore, location information may also be used to provide dynamic location based services.

### BACKGROUND OF THE INVENTION

1. Field of the Invention

The present invention relates to wireless telecommunications systems. In particular, the present invention relates to services and architectures associated with specialized services in wireless data networks.

2. Description of Related Art

Wireless data networks providing services over and above traditional voice connections are being rapidly deployed. Such wireless data networks, particularly those representing the next generation of products and services, are typically based on general packet radio service (GPRS) standards, circuit-switched wireless data network standards, mobile IP, and the like. Hardware infrastructure such as, for example, handsets, gateways and specialized servers, are further being deployed to provide the basis for software applications on these wireless data networks for such advanced application such as World Wide Web browsing, text messaging, and the like.

One such infrastructure element is the wireless application protocol (WAP), which allows simple micro-browsers to exist on wireless handsets for Web browsing. A WAP-enabled server, for example, may provide a gateway, which enables communications between IP networks and cellular networks. WAP includes wireless markup language (WML), similar to hypertext markup language (HTML), which may be used to allow Internet-related content management and display for wireless devices. The WAP specification includes consideration of limited resources available to wireless client devices as well as the limitations of the host networks such as, for example, GSM, CDMA, 3GPP, and the like and is intended to be device independent, host network independent, and thus may be used with a variety of air interfaces.

Accordingly, it would be appreciated in the art for services and architectures, which take advantage of the capabilities provided by the improved wireless networks.

### SUMMARY OF THE INVENTION

Thus in accordance with various exemplary embodiments of the present invention, a method and system are described for providing services in a wireless data network. The wireless data network includes network elements such as a mobile handset connected to a server via a wireless interface, various destination devices connected to the server through for example, a wireless interface or an Internet interface.

Accordingly, the mobile handset may form a message and transmit it to the server via the wireless interface. In forming the message, a voice cut is preferably recorded at the mobile handset and stored locally at the mobile handset. In so doing, the message is forwarded as non-real time packet data. The mobile handset may further instruct the server to push an alert to it in response to the presence of the any stored voice messages using a configuration message. The mobile handset may respond by accepting for transfer or denying for transfer the any stored voice messages which may be stored in the server.

In accordance with various alternative exemplary embodiments of the present invention, a dynamic location-based service may be provided. For example, a request may be generated from the mobile handset to the server for information associated with local services. In response, information associated with the local service providers may be provided. The mobile handset may then interact directly with the local service provider. Examples of local service providers may include restaurants, stores, government agencies, sporting venues, weather services, gaming venues, airports and the like.

In other alternative exemplary embodiments in accordance with the present invention, a wide-area remote control service may be provided. A connection may be established between the mobile handset and one or more remote devices. Control of the remote device may be accomplished from the mobile handset by transferring messages between them. Specifically, a connection may be established between the mobile handset and the server over a wireless interface and a further connection may be established between the server and the remote device over either the wireless interface and/or the Internet interface. Messages may then be transferred to effect control. As will be appreciated, the messages may include one or more voice cuts. The server is configured to translate the voice cuts to commands associated with the remote devices. Alternatively, the messages may include WAP commands and the server may be configured to translate the WAP commands to commands associated with the remote devices. Still further, the remote devices may be configured to respond directly to the one or more WAP commands.

### BRIEF DESCRIPTION OF THE DRAWINGS

The present invention will become more fully understood from the detailed description given herein below in the accompanying drawings, which are given by way of illustration only, and thus are not limitative of the present invention, and wherein:

FIG. 1 is a diagram illustrating an exemplary voice messaging server in accordance with various exemplary embodiments of the present invention; and

FIG. 2 is a diagram illustrating an exemplary wide area control server in accordance with various exemplary embodiments of the present invention.

### DETAILED DESCRIPTION OF THE DRAWINGS

Thus, in accordance with various exemplary embodiments of the present invention, architecture and services may be provided for wireless data networks as shown in the drawings. The architectures and services provided in accordance with the present invention will allow greater levels of functionality within the wireless environment.

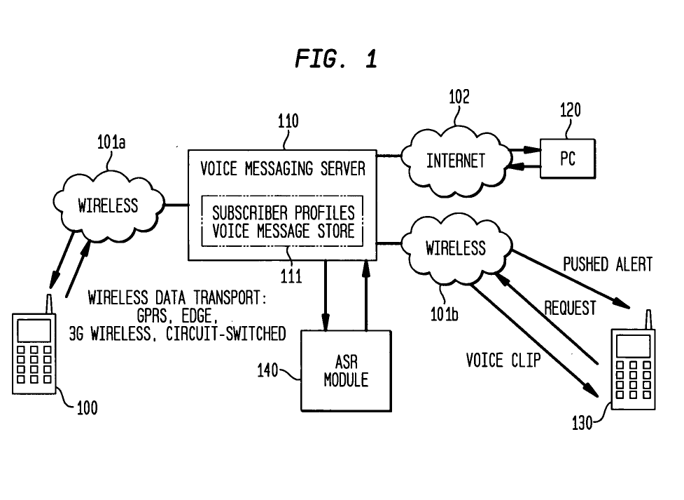

In accordance, therefore, with one exemplary embodiment, a voice messaging service may be provided as illustrated, for example, in FIG. 1. Mobile handset 100 may be used to record a voice clip to be stored locally and forwarded via wireless interface 101A to voice messaging server 110. Mobile handset 100 may use existing memo features or may be provided with special voice clip recording capabilities such as additional memory or the like. It should be noted that by pre-recording a voice clip, Quality of Service (QoS) requirements and/or streaming data requirements are unnecessary since the pre-recorded voice clip may be sent as non-real-time packet data. Moreover, in conventional networks, connection oriented service may be required for real time voice whereas voice clips recorded and stored, for example, on mobile handset 100 may be forwarded at a later time using packet-switched requirements. Thus, voice messaging server 110 may further store voice clips from subscribers along with subscriber profiles, for example, in a memory module such as memory module 111. In accordance with WAP protocols, voice clips may further be pushed, for example, via Internet connection 102 or wireless network 101B to a personal computer (PC) 120 and/or mobile handset 130, respectively.

It should further be noted that mobile handset 130 may generate a request to voice messaging server 110 to determine if any voice messages are presently stored in memory module 111. Mobile handset 130 may then play the stored voice clip or wait until a later time. It should further be noted that while a voice clip may be “pushed” to mobile handset 130, it is preferably an alert, which is pushed, rather than the voice clip itself. In this way the user of mobile handset 130 may decline to listen to the voice clip and listen to it at a later time.

It will be appreciated by those skilled in the art that several methods may be used to generate voice clips. In accordance with various exemplary embodiments of the present invention, voice clips may be recorded by, for example, a user of mobile handset 100 by pressing a single button during recording as in a memo feature presently available in many handsets. It will further be appreciated that using the capabilities of recording voice clips, other services may be provided by including a network server such as, for example, voice messaging server 110 as the destination of the voice clip. By designating voice messaging server 110 as the destination for the voice clip, voice commands may be extracted from the voice clip by the Automatic Speech Recognition (ASR) Module 140. The voice commands extracted by the ASR module 140 may be used to facilitate user interaction with the network by enabling voice commands or voice browsing for use with services such as, for example, dynamic location based services and wireless wide area remote control as will be described in greater detail hereinafter. The ASR module 140 may also provide translation services for translating the voice clip from an audio format to, for example, a text format for forwarding to a destination device.

Is should be further noted that the system may provide user authentication. This authentication may be based on a number of techniques, such as a numeric password entered by the user on the phone keypad, a verbal password spoken by the user or speech recognition based on a verbal phrase spoken by the user. The ASR module 140 may provide the verbal password and speech recognition based on a verbal phrase services.

In accordance with various exemplary embodiments of the present invention, a dynamic location-based service may be provided wherein a subscriber such as, for example, a user of mobile handset 100 enters an area during travel. The location of the subscriber may be determined by methods known in the art such as identifying the base station handling the communication, or global positioning satellite (GPS). Once the location of the subscriber is known, the subscriber may then generate a request for local based services such as, for example, local restaurants. In contrast with existing systems for broadcasting such local information, a subscriber in accordance with various exemplary embodiments of the present invention may interact with local establishments of their choice. It will be appreciated that in response to a request for local based services, a list may be returned containing a variety of selections in response thereto. If the list, for example, contains a number of local restaurants, a subscriber may query each restaurant as to specials, dress codes, prices, and the like, by interacting with each restaurant via an interface. In order to limit the need for entering data manually, the interface may be voice driven and may respond to voice clips recorded as described hereinabove. It will further be appreciated that while the present example includes restaurants, other services easily fall within the scope of the present invention such as, for example, retail stores, local events, government-sponsored events, emergency services, weather advisories, airport schedules, sports events, gambling-related events, and the like. In addition, reservations may be made as well as the display of advertisings in response to which related purchasing may be performed over the interface.

In addition, dynamic location-based services in accordance with various exemplary embodiments of the present invention may be used to control the delivery of services, which may be shown via an advertisement of services and service options. A selection may then be sent from a subscriber directly to the service provider in response thereto. It should further be noted that subscribers may be notified of service providers in a particular vicinity or even other subscribers within a particular vicinity by way of proximity alerts. Proximity alerts may be generated at a service provider or subscriber in the form of a text or voice message clip and may be sent, for example, via a messaging server such as, for example, messaging server 110 over a wireless interface such as, for example, wireless interface 101B to a mobile handset associated with the subscriber such as, for example, mobile handset 130.

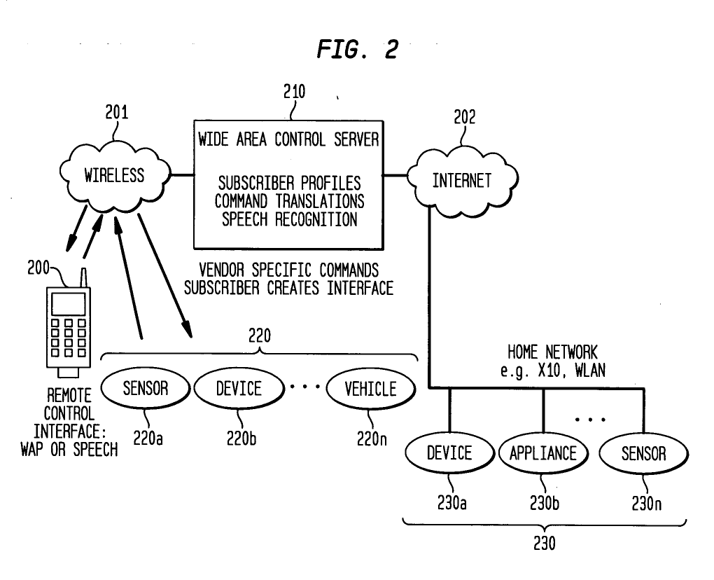

In accordance with various alternative exemplary embodiments of the present invention, a wireless wide-area remote control service may be provided as illustrated in FIG. 2. Therein it can be seen that mobile handset 200 may provide a remote control interface through either WAP commands or voice clips as previously described to wireless accessed devices such as sensor 220a or device 220b directly through wireless interface 201. In order to effect remote control of such devices, connections may be established from a mobile handset 200 to devices 220. Alternatively, remote device 230, as may be connected to, for example, a home network, wide-area LAN or the like and which may include a remote device 230a, appliance 230b or one or more sensors 230n may be controlled via wide-area control server 210 over, for example, Internet connection 202. Wide area control server 210 may contain subscriber profiles, which aid in command translation, speech recognition, and processing specific commands made possible by a custom interface, which may be configured by the subscriber. It should be noted that remote devices 230 may include various smart devices such as simple on/off devices, thermostats, garage door openers, security sensors, household locks, televisions, vehicles, and the like. It should further be noted that devices 220 may include similar devices configured for wireless connections.

The invention being thus described, it will be obvious to those skilled in the art that a multitude of variations may be possible in accordance with the present invention. Such variations are not to be regarded as departure from the invention and all such modifications are intended to be included where appropriate within the scope of the following claims.

We claim:

1. A method for providing wireless voice messaging services in a wireless data network, the method comprising:
creating a message stored locally at a mobile station including message destination information and recorded voice data; and
sending the locally stored message over a wireless interface as non-real time packet data.

2. The method of claim 1, wherein the recorded voice data is recorded at a mobile station.

3. The method of claim 1, wherein the message destination information identifies one or more destination devices.

4. The method of claim 3, wherein the message destination information is selected from a local address book or a network accessible address book.

5. The method of claim 1, wherein the recorded voice data includes voice commands.

6. The method of claim 1, wherein the message includes location information of the mobile station.

7. A method for providing wireless voice messaging services in a wireless data network, the method comprising:
receiving at a server as non-real time data a message including message destination information and recorded voice data;
sending the message, from the server to a destination device identified in the message destination information, over one or more of a wireless interface and an Internet interface.

8. The method of claim 7, wherein the sending step sends the message as non-real time data.

9. The method of claim 7, wherein the sending step sends the message as packet data.

10. The method of claim 7, wherein the message is a notification of people, places, or devices in a local proximity of the destination device.

11. The method of claim 7, wherein the message is a notification of services available in a local proximity of the destination device.

12. The method of claim 7, further comprising:
storing the message at the server;
sending an alert to the destination device alerting the destination device that the server stores a message destined for the destination device; and
receiving a request from the destination device requesting transfer of the stored message;
wherein the message sending step sends the message from the server to the destination device after receipt of the request from the destination device requesting transfer of the stored message.

13. The method of claim 12, wherein the sending step sends the message as non-real time data.

14. The method of claim 12, wherein the sending step sends the message as packet data.

15. The method of claim 7, further comprising:
extracting corresponding text data from the recorded voice data; and
replacing in the message the recorded voice data with the corresponding text data.

16. The method of claim 15, wherein the recorded voice data is replaced with the corresponding text data based on the destination information.

17. The method of claim 7, further comprising:
receiving at the server a request for service; and
authenticating the request for service;
wherein the received messages are sent to a destination device based on the authenticating step.

18. A method for providing wireless voice control services in a wireless data network, the method comprising:
receiving a message at a server as non-real time data, the message including message destination information and recorded voice data, the message destination information identifying the server as a destination device;
extracting voice commands from the recorded voice data; and
executing the extracted voice commands.

19. The method of claim 18, wherein the extracted voice commands are voice browsing instructions.

20. The method of claim 18, wherein the executing of the extracted voice commands is based on a location of a mobile station.

21. A method for providing a wide-area remote control service, the method comprising:
establishing a connection at a server with a mobile station over a wireless interface;
establishing a connection at the server with one or more remote devices over the wireless interface or an Internet interface;
receiving at the server as non-real time data a message including message destination information and recorded voice data;
translating the received message from a format including message destination information and recorded voice data to a second message format; and
sending the translated message from the server to one or more of the connected remote devices.

22. The method of claim 21, wherein
the recorded voice data includes one or more voice commands; and
the second message format includes the destination information and one or more formatted commands corresponding to the one or more voice commands, the formatted commands formatted for the one or more connected remote devices.

23. The method of claim 21, wherein
the recorded voice data includes one or more voice commands; and
the second message format includes one or more WAP commands corresponding to the one or more voice commands.

24. The method of claim 21, wherein the translating step modifies the destination information based on a location of the mobile station.
